(19) United States
(12) Patent Application Publication
(10) Pub. No.: US 2006/0050891 A1
(43) Pub. Date: Mar. 9, 2006

(54) Method for automatic loudspeaker polarity determination through loudspeaker-room acoustic responses

(76) Inventor: Sunil Bharitkar, Los Angeles, CA (US)

Correspondence Address: Dr. Sunil Bharitkar, Ste. 1, 2461 Coolidge Ave., Los Angeles, CA, 90064, US

(21) Appl. No.: 10/935,564

(22) Filed: Sep. 7, 2004

(51) Int. Cl. H04R 29/00

(52) U.S. Cl. 381/59; 381/96; 381/58

(57) ABSTRACT

A method for determining the polarity of a loudspeaker including measuring a loudspeaker-room acoustical response at a position with a microphone and filtering the loudspeaker-room acoustical response for increasing the signal to noise ratio of a first peak corresponding to direct sound in the loudspeaker-room acoustical response, wherein the sign of a sample in the first peak in the filtered loudspeaker-room acoustical response indicates the polarity of the loudspeaker.

### BACKGROUND

1. Field of the Invention

The present invention relates to loudspeaker systems and particularly to the delivery of sound image optimized signals in mono or multi-channel audio through loudspeakers in an enclosure.

2. Description of the Background Art

In a stereo or multi-channel sound reproduction system, the polarities of the loudspeakers must be coincident with those of speaker terminals of an amplifier or home theater receiver. The state of coincidence of the connection polarities (or “in-phase” polarity) of the loudspeakers implies a state where all of “plus” and “minus” terminals of the loudspeakers are respectively connected to plus and minus speaker terminals of the corresponding channels of an amplifier for: (i) optimizing the sound image, (ii) avoiding sound cancellations in the playback region, (iii) avoiding loss of acoustical efficiency, and (v) aiding the playback of an enhanced sound stage.

The state of non-coincidence of the connection polarities (viz., “out-of-phase” polarity) of loudspeakers implies a state where the plus and minus terminal of at least one of the loudspeakers (e.g., left loudspeaker of the left channel in a stereo reproduction) are respectively connected to minus and plus terminals of the corresponding channel of an amplifier or home-theater receiver causing a degradation of sound image in the playback audio and causing unwanted sound cancellations.

As a method of determining whether or not coincidence (viz., in-phase polarity) of the connection polarities of left and right loudspeakers are attained, for optimized sound image reproduction, a method is used where a test signal is reproduced from both the loudspeakers (e.g., the left and right loudspeakers connected to the left and right channels of an amplifier or home-theater receiver in a stereo reproduction). When the reproduced sound is localized at the midpoint between the left and right loudspeakers, for example, the reproduced sounds of the left and right loudspeakers are in-phase in polarity, and it is therefore determined that coincidence of the connection polarities of the loudspeakers is attained. In this case, the connections of the loudspeakers with the terminals of the receiver are not reversed.

In contrast, when the reproduced sound is localized outside the left and right loudspeakers, for example, the reproduced sounds of the left and right loudspeakers are out-of-phase in polarity thereby conveying the non-coincidence of the connection polarities. In such a case, the connection polarity of the loudspeaker of one channel must be reversed to get the correct sound image.

In the above determining method, it is difficult to determine whether or not coincidence of the connection polarities of left and right loudspeakers is attained because of the following reasons.

(a) Problem due to absolute evaluation: Only one sound is used in determining whether the sound is positive-phase or negative-phase, and hence the determination is based on absolute evaluation. Since there is no reference for comparison, skills are required for the determination.

(b) Problem due to standing wave: In the case where a test signal having only one frequency component is used, when the frequency is close to that of the standing wave of the room, interference between the test signal and the standing wave may cause polarities to be incorrectly determined.

(c) Using any test signal, in listening tests, for determining the sound image can only provide an indication of relative polarity between any two loudspeakers. Thus, the time to check multiple loudspeakers (e.g., a ten channel loudspeaker system) can be quite high.

(d) Many home-theater receivers and amplifiers are sold to consumers that have little to no knowledge of performing listening tests, and this may lead to erroneous polarity determination.

Prior art inventions (e.g., U.S. Pat. No. 6,681,019 issued Jan. 20, 2004) rely on test signals, such as filtered white noise signals and musical sounds, to identify the relative polarity between loudspeakers. Examples of other prior art for determining relative polarity include U.S. Pat. No. 4,908,868. The prior art of U.S. Pat. No. 5,319,714 requires complex analog processing circuitry to produce an inverted and non-inverted version of the received signal for analysis and comparisons, through comparators, for determining polarity. Furthermore, the reference/stimuli signal, in the afore-stated prior art, had to be designed carefully and in fact the positive polarity and a fast rise times were considered to be critical.

The prior art invention of Donald G. Fink in U.S. Pat. No. 3,067,297 relates to the stimulation of the channel under test with an asymmetrical impulse waveform and then determining absolute phase polarity of the channel by observing its output with an oscilloscope or an asymmetry indicator based on a reversibly switched quasi-peak amplitude detector utilizing a vacuum tube diode. The Fink apparatus, being confined to the testing of electrical circuits, typically inter-studio wired lines, may have functioned adequately for that purpose, however it did not anticipate acoustic testing through a microphone and thus failed to address certain inherent problems associated therewith.

### SUMMARY OF THE INVENTION

The inventor has recognized that the acoustics of a loudspeaker and room, as characterized by the loudspeaker-room acoustical response, can be used to determine the absolute polarity of a loudspeaker under test without using subjective tests or complex analog processing circuitry, and with arbitrary stimulus signals.

A typical loudspeaker-room chain can be modeled as a linear system whose behavior at a particular listening position is characterized by a loudspeaker-room impulse response, h(n) {n=0, 1, . . . , N-1}. The impulse response yields a complete description of the changes a sound signal undergoes when it travels from a loudspeaker to a microphone. The signal at the microphone thus consists of direct path sound, discrete reflections that arrive a few milliseconds after the direct path, as well as a reverberant field component.

A typical process to measure a room response is (i) by delivering a stimuli signal, such as a chirp, white noise, pink noise, maximum length sequence, narrowband or a broadband signal, to the loudspeaker, (ii) capturing the received signal, and (iii) de-convolving the room impulse response from the received or measured signal. De-convolution is well known in the art and there are adequate references that cover this technique such as “Deconvolution and Inverse Theory” by Vijay Dimri (Elseveir Publishing, 1992). An example of a loudspeaker-room impulse response of 8192 samples duration sampled at 48 kHz is shown in FIG. 1, whereas FIG. 2 shows a zoomed in view of the first few samples of the impulse response, constituting the direct path and the early reflections as well as some noise (ringing in the response, ambient noise and other frequency dependent effects) preceding the first peak.

Thus, in one aspect a method for determining the polarity of a loudspeaker comprises: (i) determining a loudspeaker-room acoustical response from a measured signal with a microphone; (ii) filtering the loudspeaker-room acoustical response for increasing the signal to noise ratio of a first peak corresponding to direct sound (viz., direct path) in the loudspeaker-room acoustical response; and (iii) determining the sign of a sample in the first peak in the filtered loudspeaker-room acoustical response; wherein the sign of the sample in the first peak in the filtered loudspeaker-room acoustical response indicates the polarity of the loudspeaker.

In one aspect, the measured signal is a filtered version of at least one of a chirp, white noise, pink noise, maximum length sequence, narrowband or a broadband signal, and the loudspeaker-room acoustical response is determined through de-convolution.

In one aspect, the noise includes at least one of ambient noise, ringing before a first sample corresponding to the direct path, and/or other effects following the first peak.

Furthermore, the method includes the step of comparing the sign of the sample in the first peak in the filtered loudspeaker-room acoustical response with a polarity of the microphone for determining the polarity of the loudspeaker. In one aspect, the polarity of the loudspeaker is positive if the sign of the sample in the first peak in the filtered loudspeaker-room acoustical response is positive and the polarity of the microphone is positive. In another aspect, the polarity of the loudspeaker is positive if the sign of the sample in the first peak in the filtered loudspeaker-room acoustical response is negative and the polarity of the microphone is negative. In another aspect, the polarity of the loudspeaker is negative if the sign of the sample in the first peak in the filtered loudspeaker-room acoustical response is negative and the polarity of the microphone is positive. In yet another aspect, the polarity of the loudspeaker is negative if the sign of the sample in the first peak in the filtered loudspeaker-room acoustical response is positive and the polarity of the microphone is negative.

In one aspect, the filter for filtering the raw loudspeaker-room acoustical response is a low pass filter for enhancing the first peak corresponding to the direct sound (viz., direct path) along the time and amplitude axis of the loudspeaker-room acoustical room response. Additionally, the sample in the first peak is determined by comparing the amplitude of a time domain sample of the filtered loudspeaker-room acoustical response with a threshold, said sample in the first peak being greater in amplitude than the threshold.

### BRIEF DESCRIPTION OF THE DRAWINGS

FIG. 1 shows an exemplary loudspeaker-room impulse response measured at a 48 kHz sampling rate as measured with a negative polarity microphone;

FIG. 2 shows a zoomed version of the loudspeaker-room response of FIG. 1 along with the direct path (viz., direct sound) and some early reflections, as well as some pre-ringing and ambient noise effects;

FIG. 3 is a one-third octave smoothed magnitude response of an exemplary filter, according to one embodiment, for removing the ringing, noise and other effects for enhancing the first peak corresponding to the direct path;

FIG. 4 shows a low-pass filtered loudspeaker-room acoustic impulse response, corresponding to the response measured in FIG. 1, showing the removal of noise, ringing effects and the enhancement of the first peak in time and amplitude thereby allowing the determination of a positive polarity (in-phase) for the loudspeaker with the negative polarity microphone;

FIG. 5 shows the samples of the time domain filtered loudspeaker-room acoustical response of FIG. 4;

FIG. 6 is a flow chart depicting the process for determining the polarity of a loudspeaker.

FIG. 7 shows a filtered loudspeaker-room acoustic impulse response, corresponding to another measured response, showing the removal of noise, ringing effects and the enhancement of the positively signed first peak in time and amplitude thereby allowing the determination of a negative polarity (out-of-phase) for the loudspeaker with the negative polarity microphone;

FIG. 8 shows a filtered loudspeaker-room acoustic impulse response, corresponding to another measured response, showing the removal of noise, ringing effects and the enhancement of the positively signed first peak in time and amplitude thereby allowing the determination of a positive polarity (in-phase) for the loudspeaker with a positive polarity microphone;

FIG. 9 shows a filtered loudspeaker-room acoustic impulse response, corresponding to another measured response, showing the removal of noise, ringing effects and the enhancement of the negatively signed first peak in time and amplitude thereby allowing the determination of a negative polarity (out-of-phase) for the loudspeaker with a positive polarity microphone.

### DESCRIPTION OF THE PREFERRED EMBODIMENTS

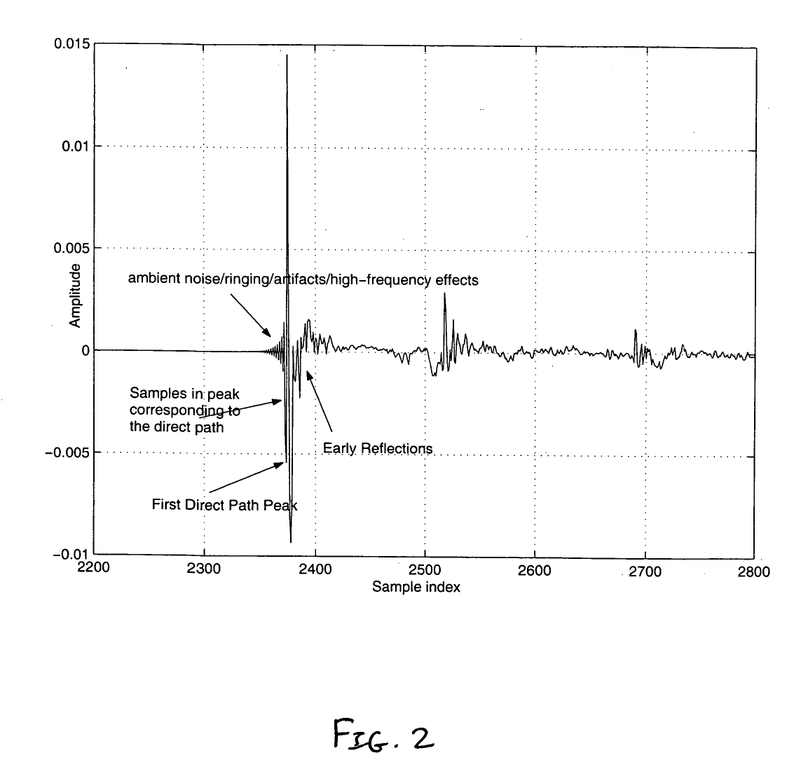

Shown in FIG. 2 is the direct path peak, as depicted by the first negative going peak, measured by a microphone with a negative polarity. Accordingly, any arbitrary signal that is convolved with this loudspeaker-room response will be measured, by the present microphone, with a negative sign of the first peak. Thus, this constitutes that the actual loudspeaker polarity is in phase (i.e., the positive terminal of the receiver/amplifier is connected to the positive terminal of the speaker and the negative terminal from the receiver is connected to the negative terminal of the speaker) since with a positive polarity microphone, the received signal will have a positive going first peak corresponding to the direct path. The polarity can be determined by the sign of this first peak of the direct path or via the sign of the samples in the first peak (also generally shown in FIG. 2). However, accurate determination of the main peak or any sample in the main peak, via automatic methods, will be hindered by the presence of pre-ringing, noise, and other frequency dependent effects shown in FIG. 2.

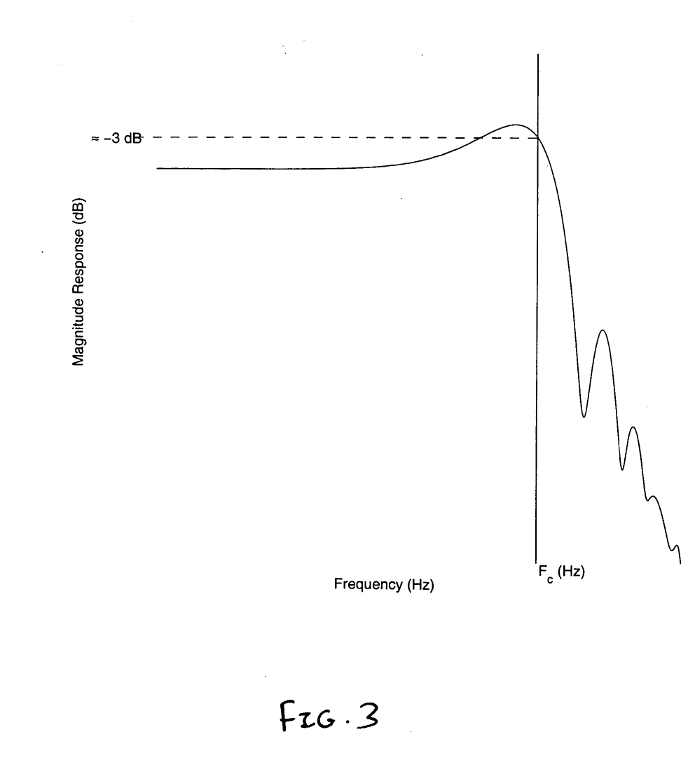

FIG. 3 shows an exemplary low-pass filter for minimizing the extraneous effects (noise, ringing, high frequency effects) for enhancing the first peak, by filtering the loudspeaker-room response, in order to allow reliable detection of any sample in the first peak for accurate polarity indication. The cutoff frequency F_{c} (Hz) for the low pass filter can be anywhere in between 20 Hz and 20 kHz. In the exemplary embodiment F_{c} was selected around 1.125 kHz.

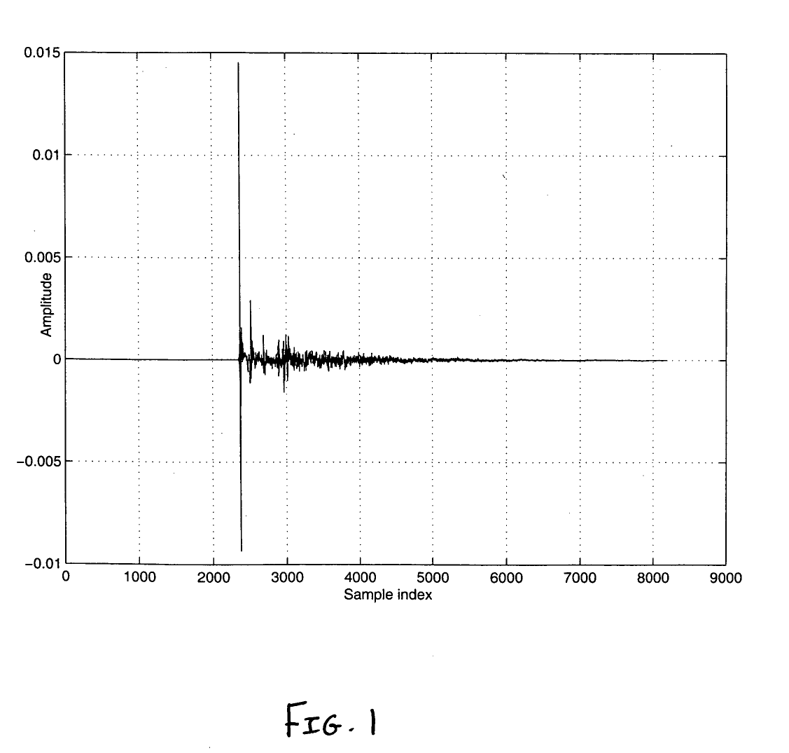

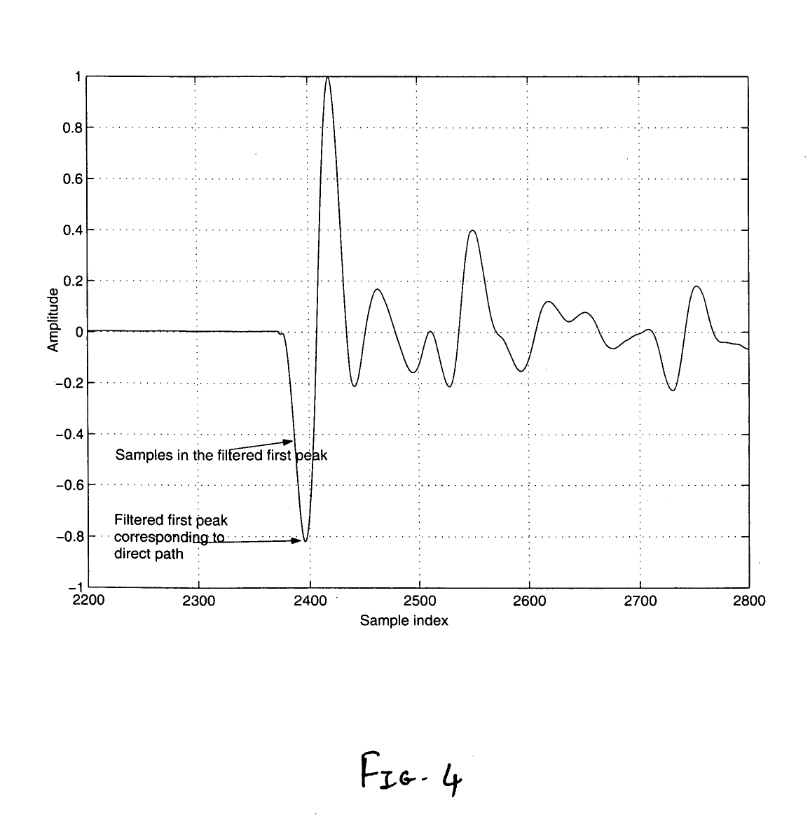

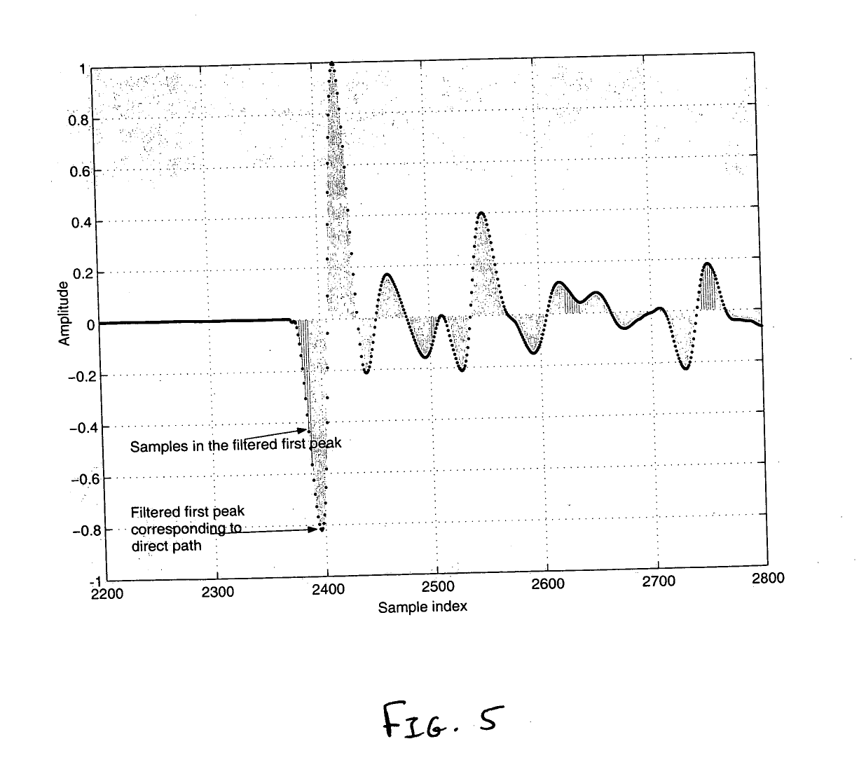

FIG. 4 shows a low-pass filtered loudspeaker-room acoustic impulse response, corresponding to the response measured in FIG. 1, showing the removal of noise, ringing effects and the enhancement of the first peak in time and amplitude for reliable determination of polarity for the loudspeaker with the negative polarity microphone. FIG. 5 shows the discrete version of FIG. 4 including the samples in the first peak.

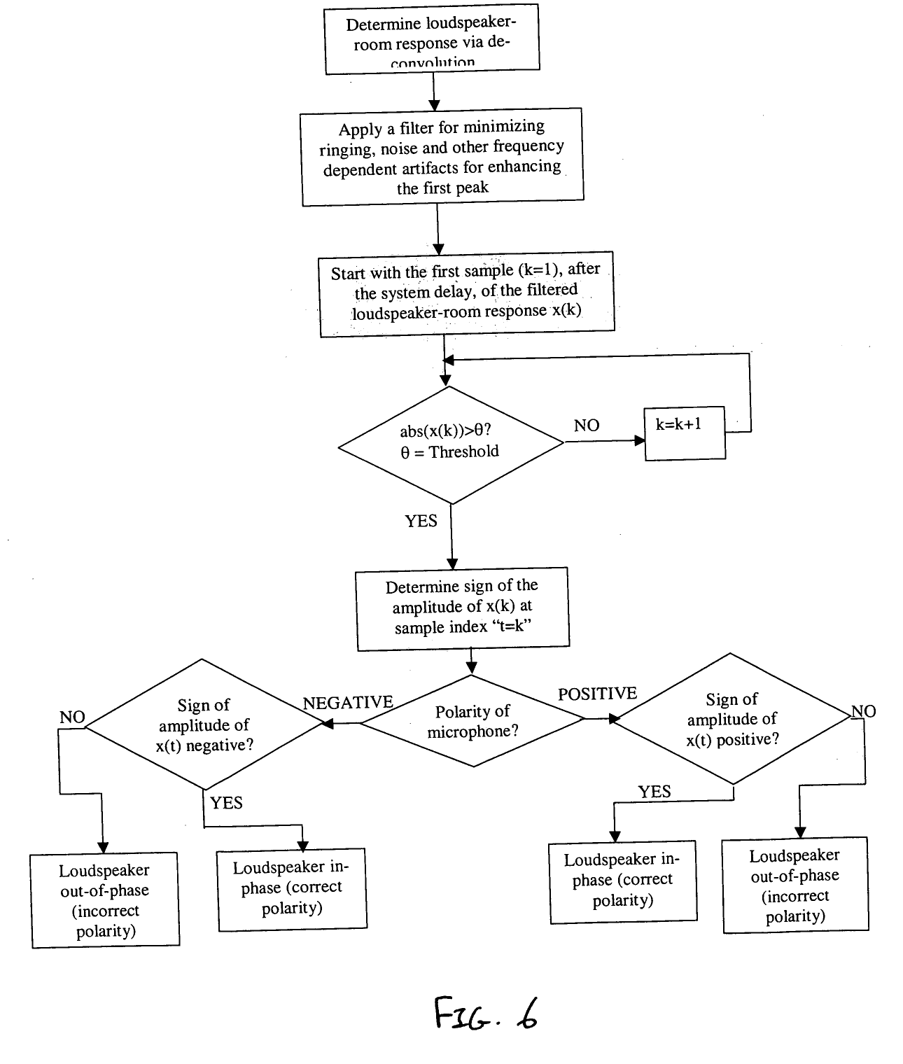

The algorithm for polarity determination of the loudspeaker is shown in FIG. 6. Specifically, the loudspeaker-room response is determined via a de-convolution process that removes the influence of the transmitted signal from the measured signal. The loudspeaker-room acoustical impulse response is then filtered by a low-pass filter whose exemplary magnitude response, having an F_{c} of about 1.125 kHz, is shown in FIG. 3. Once the ringing, noise, and other artifacts are removed via the filtering process, as evident from FIG. 4, the first peak corresponding to the direct path is substantially enhanced. This process can be interpreted as increasing the signal to noise ratio, where the signal of interest corresponds to the first peak and the noise corresponds to ambient noise, ringing and other artifacts. The filtered first peak or the samples in the first peak now allow reliable determination of the polarity through the remaining steps.

The absolute value of a sample, starting from the first sample, in the filtered loudspeaker-room response is compared to a threshold. When the absolute value of a particular sample is found to exceed the threshold, the sign of that sample (via it's amplitude value) is compared with the polarity of the microphone used. For a negative polarity microphone, if the sign of the sample exceeding the threshold is found to be negative then the polarity of the loudspeaker is considered “in-phase”, whereas if the sign of the sample exceeding the threshold is found to be positive then the polarity of the loudspeaker is considered “out-of-phase”. Similarly, for a positive polarity microphone, if the sign of the sample exceeding the threshold is found to be positive then the polarity of the loudspeaker is considered “in-phase”, whereas if the sign of the sample exceeding the threshold is found to be negative then the polarity of the loudspeaker is considered “out-of-phase”.

In one aspect, the threshold was determined from the maximum amplitude of the filtered loudspeaker-room response between the first sample and the sample corresponding to the system delay for the home-theater receiver/amplifier. In the case of the exemplary receiver, used for the loudspeaker-room responses, the system delay constituted a bout 1995 samples from the start of the loudspeaker-room response. In alternative aspects, the threshold may be determined from the mean instead of the maximum and in arbitrary time window.

Thus, for the loudspeaker-room response of FIG. 4, the polarity was correctly determined as positive (in-phase) based on the negative sign of the sample at sample index 2380.

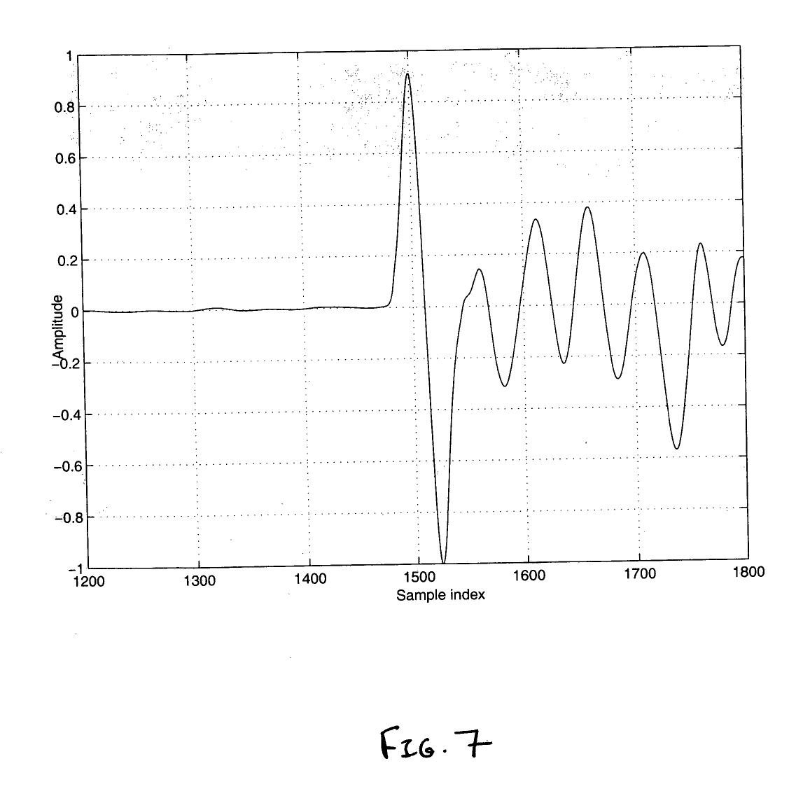

FIG. 7 shows a filtered loudspeaker-room acoustic impulse response, corresponding to another measured response, showing the removal of noise, ringing effects and the enhancement of the first peak in time and amplitude thereby allowing the determination of a negative polarity (out-of-phase), due to the positive signed first peak, for the loudspeaker with the negative polarity microphone. The system delay in this response was about 960 samples, whereas the out-of-phase polarity was correctly determined based on the positive sign of the sample at sample index 1481.

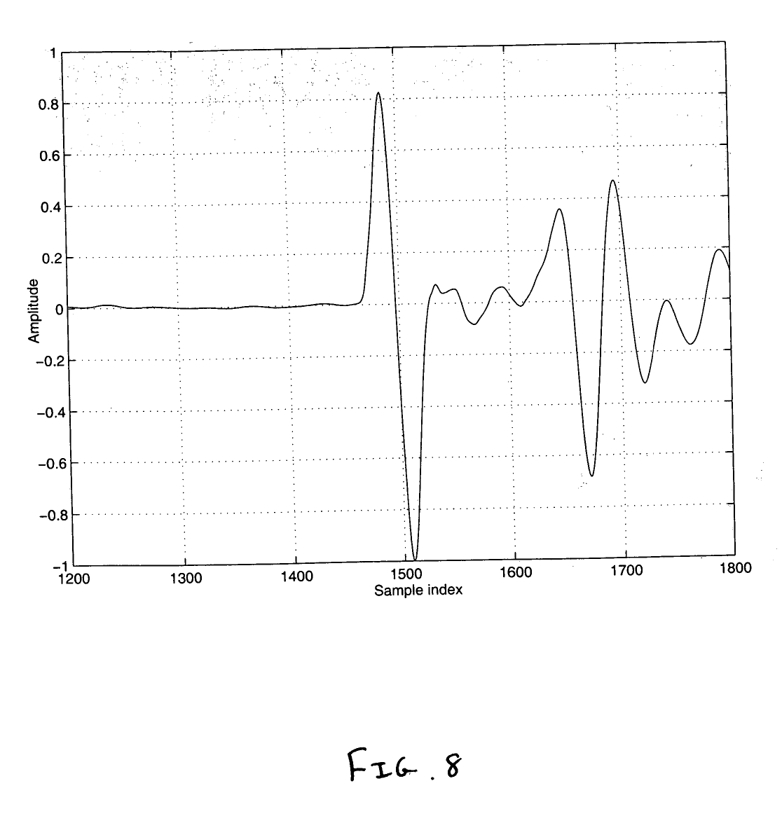

FIG. 8 shows a filtered loudspeaker-room acoustic impulse response, corresponding to another measured response, showing the removal of noise, ringing effects and the enhancement of the first peak in time and amplitude thereby allowing the determination of in-phase polarity, due to the positive signed first peak, for the loudspeaker with a positive polarity microphone. The system delay in this response was about 960 samples, whereas the out-of-phase polarity was correctly determined based on the positive sign of the sample at sample index 1468.

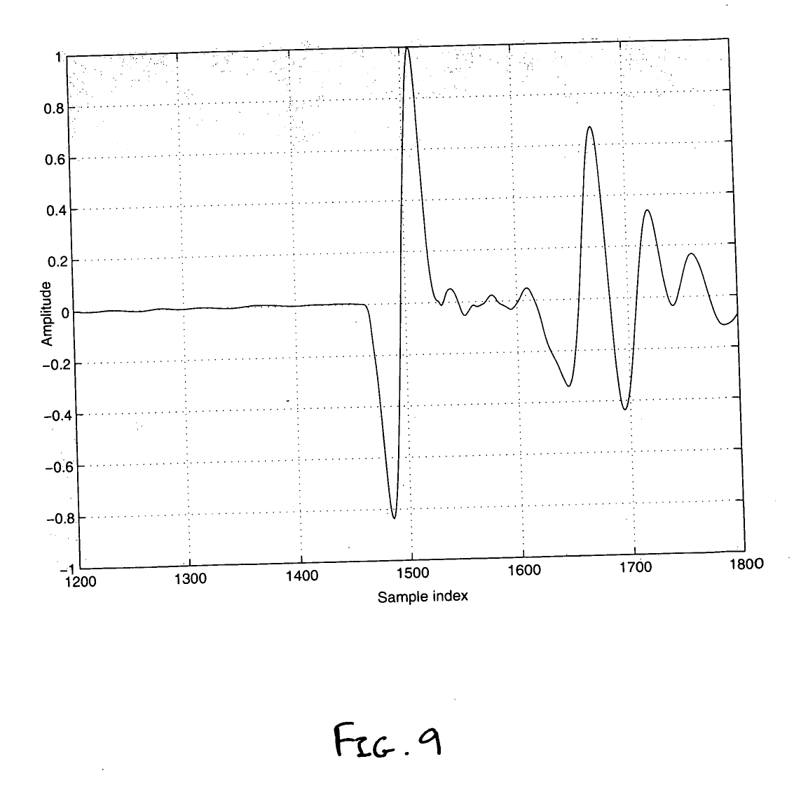

FIG. 9 shows a filtered loudspeaker-room acoustic impulse response, corresponding to another measured response, showing the removal of noise, ringing effects and the enhancement of the first peak in time and amplitude thereby allowing the determination of a negative polarity (out-of-phase), due to the negative signed first peak, for the loudspeaker with a positive polarity microphone. The system delay in this response was about 960 samples, whereas the out-of-phase polarity was correctly determined based on the positive sign of the sample at sample index 1467.

The description of exemplary and anticipated embodiments of the invention has been presented for the purposes of illustration and description purposes. They are not intended to be exhaustive or to limit the invention to the precise forms disclosed. Many modifications and variations are possible in light of the teachings herein. For example, the low-pass filter may have arbitrary cutoff frequencies and amplitude response in the frequency range of hearing (20 Hz through 20 kHz), the threshold may be determined through other means such as via a noise power approach.

We claim:

1. A method for determining the polarity of a loudspeaker, the method comprising:
determining a loudspeaker-room acoustical response from a signal measured with a microphone;
filtering the loudspeaker-room acoustical response for increasing the signal to noise ratio of a first peak in the loudspeaker-room acoustical response; and
determining the sign of a sample in the first peak in the filtered loudspeaker-room acoustical response;
wherein the sign of the sample in the first peak in the filtered loudspeaker-room acoustical response indicates the polarity of the loudspeaker.

2. The method according to claim 1, wherein the noise includes the ambient noise.

3. The method according to claim 1, wherein the noise includes ringing before a first sample corresponding to the direct sound.

4. The method according to claim 1, further including the step of comparing the sign of the sample in the first peak in the filtered loudspeaker-room acoustical response with a polarity of the microphone for determining the polarity of the loudspeaker.

5. The method according to claim 1, wherein the filter is a low pass filter for enhancing the first peak along the time and amplitude axis of the loudspeaker-room acoustical room response.

6. The method according to claim 4, wherein the polarity of the loudspeaker is positive if the sign of the sample in the first peak in the filtered loudspeaker-room acoustical response is positive and the polarity of the microphone is positive.

7. The method according to claim 4, wherein the polarity of the loudspeaker is positive if the sign of the sample in the first peak in the filtered loudspeaker-room acoustical response is negative and the polarity of the microphone is negative.

8. The method according to claim 4, wherein the polarity of the loudspeaker is negative if the sign of the sample in the first peak in the filtered loudspeaker-room acoustical response is negative and the polarity of the microphone is positive.

9. The method according to claim 4, wherein the polarity of the loudspeaker is negative if the sign of the sample in the first peak in the filtered loudspeaker-room acoustical response is positive and the polarity of the microphone is negative.

10. The method according to claim 1, wherein the sample in the first peak is determined by comparing the amplitude of a time domain sample of the filtered loudspeaker-room acoustical response with a threshold, said sample in the first peak being greater in amplitude than the threshold.

11. The method according to claim 1, wherein the loudspeaker-room acoustical response is determined through de-convolution.

12. The method according to claim 11, wherein the measured signal is a filtered version of at least one of a chirp, white noise, pink noise, maximum length sequence, narrowband or a broadband signal.

13. A method for determining the polarity of a loudspeaker, the method comprising:
determining a loudspeaker-room acoustical response from a signal measured with a microphone; and
determining the sign of a sample in the first peak in the filtered loudspeaker-room acoustical response;
wherein the sign of the sample in the first peak in the loudspeaker-room acoustical response indicates the polarity of the loudspeaker.

14. The method according to claim 13, further including the step of comparing the sign of the sample in the first peak in the filtered loudspeaker-room acoustical response with a polarity of the microphone for determining the polarity of the loudspeaker.
